(19) United States
(12) Patent Application Publication
(10) Pub. No.: US 2005/0289384 A1
(43) Pub. Date: Dec. 29, 2005

(54) Apparatus and method for controlling the delivery of an event message in a cluster system

(75) Inventor: Donald Edward Kehl, Ripon, WI (US)

Correspondence Address: COHEN, PONTANI, LIEBERMAN & PAVANE;Suite 1210, 551 Fifth Avenue, New York, NY, 10176, US

(73) Assignee: Fujitsu Siemens Computers, Inc., Munchen (DE)

(21) Appl. No.: 11/125,476

(22) Filed: May 9, 2005

(30) Foreign Application Priority Data
Nov. 7, 2003 (WO) PCT/EP03/12474

(51) Int. Cl. G06F 11/00

(52) U.S. Cl. 714/4

(57) ABSTRACT

An apparatus and a method for controlling the delivery of an event message of an event in a cluster system is provided. The apparatus delivers a received event message to the receivers registered for the event message in a specific order. The specific order is determined by a sequence number which is assigned to each of the receivers. Exchanging the sequence number between different nodes in a cluster enables delivery of the event in a specific order on a cluster-wide basis. Errors due to wrong event delivery are thereby prevented.

### RELATED APPLICATIONS

This is a continuation of International Application No. PCT/EP2003/012474, filed on Nov. 7, 2003, which claims priority from U.S. provisional application No. 60/424,458 filed Nov. 7, 2002, the contents of which is hereby incorporated by reference.

### FIELD OF THE INVENTION

The invention refers to an apparatus in a node of a cluster system. The invention refers also to a method for controlling the delivery of an event message.

### BACKGROUND OF THE INVENTION

In a cluster system comprising different nodes it is necessary to provide a reliable event notification service to broadcast an event occurring in the cluster system. Those event messages are delivered to different receivers, mostly implemented by software programs, performing additional tasks upon receiving the event messages.

Cluster is a widely-used term meaning independent computers combined into a unified system through software and networking. At the most fundamental level, when two or more computers are used together to solve a problem, it is considered a cluster. Cluster systems provide convenient and cost-effective platforms for executing complex computation-, data-, and/or transaction-oriented applications. A “node” is a logical and/or physical member of a cluster and is basically the same as a computer. A user manual is available from Fujitsu Siemens Computers, Inc., the assignee of the present invention, titled “PRIMECLUSTER, Concepts Guide (Solaris, Linux),” April 2003 Edition. It provides detailed information about concepts related to cluster systems.

A receiver is a component which receives a message for a node in a cluster. The receiver, can be a software program designed to receive specific messages.

An event is an incident or occurrence. In the context of the present invention, this term generally describes an incident in the cluster, e.g. a node failure. In the field of computer sciences, the term is applied when an application performs some action influencing the behaviour of software or hardware within a computer. For example, moving a mouse triggers an interrupt, resulting in a “mouse move event”, and requesting disk access results in an “access event”. These are so called low level events, since the hardware of a computer is addresses directly (by interrupt calls). Of course, there are also high level events. For example, the “task manager” in Windows checks the functionality of applications. If an application does not provide a feedback upon request, the task manager generates a “no feedback” event. Terminating the application will also generate an event. Software or hardware events are common among Unix systems.

An example of such an event notification service (ENS) is shown in FIG. 6. Two nodes N1 and N2 are part of a cluster system. They are connected over a network N for communication purposes. On each node a cluster foundation software CF is executed which provides functions for handling communications between the two nodes. The cluster foundation software CF provides maintaining, controlling and communicating functions throughout the cluster system. The functions provided by the cluster foundation software CF are also used by the event notification service ENS running on each node.

Furthermore, the software programs GDS (Global Disk System), GFS (Global File System) and OPS (Oracle Parallel Server) run as cluster subsystems on node N1. They perform different tasks. When an event occurrs in node N2, a message related to the event is sent by the event notification service ENS of node N2 via the cluster foundation software CF throughout the cluster system in order to allow different software applications on other nodes in the cluster system (also referred to herein simply as “cluster”) to perform tasks dependent on the event.

The event message (or notification) is received by the event notification service ENS of node N1. In this example, it is a “NODE_LEFT” event, declaring that the node N2 will leave the cluster soon. Therefore, the subsystems GDS, GFS and OPS have to be notified of that occurrence to carry out the necessary arrangements. However, in the prior art implementation, the event notification broadcast to the parallel server OPS, the global file system GFS and the global disk system GDS is asynchronous. If the three software applications OPS, GFS and GDS are dependent on each other, the delivery of the event notification may cause problems. For example, if GDS is needed by the global file system GFS to write data on a storage device but the global disk system GDS has already shut down the storage device due to the event notification broadcast, an error will occur. In the worst case, the entire cluster system will contain inconsistencies or the node might crash.

### SUMMARY OF THE INVENTION

One object of the present invention is to overcome the drawback of an asynchronous delivery.

Another object of the present invention is to substantially reduce the possibility of an error due to a wrong event notification.

These and other objects are attained in accordance with one aspect of the present invention directed to an appliance for use in at least one node of a cluster system, wherein the cluster system comprises at least two nodes in communication with each other over a network, and at least one node comprises at least two receivers coupled to said appliance via a connection, wherein said appliance comprises means for receiving an event message related to an event occurring within the cluster system; and means for delivering the event message to the at least two receivers via the connection in a specific order determined by a sequence number assigned to each one of the at least two receivers.

Another aspect of the present invention is directed to a method for controlling delivery of an event message related to an event occurring in a cluster system, wherein the cluster system comprises at least two nodes, and at least one of the at least two nodes comprises at least two receivers, wherein the method is implemented in the at least one of the at least two node and comprises the steps of a) receiving the event message to be delivered to the at least two receivers; and b) delivering the event message to the at least two receivers in a specific order determined by a sequence number connected to each of the at least two receivers.

An embodiment of the present invention provides an apparatus and a method for delivering events to receivers, mainly implemented by software programs, in a specific order. The receivers are registered for receiving the event message. The delivery order is determined by a sequence number. Assigning the sequence number to each of the receivers enables broadcasting the event notification to the receivers in a specific order, wherein an error or crash due to asynchronous delivery is prevented. The receivers that the event has to be delivered to are not independent from each other but, instead, are connected and arranged by the sequence number. The apparatus will coordinate and sequence the delivery of each event message to the receivers registered for that event. The phrase “delivering an event” or “delivering an event message for an event” have the same meaning for this invention.

In one embodiment of the invention, the receivers can be registered to more than one event message. Furthermore, the receivers can be registered with different sequence numbers to each event. In those embodiments for which the receivers can be registered to more than one event, each receiver can be connected to different sequence numbers. This allows a higher flexibility and also a later change of the delivery order or the upgrade of the receivers.

In one embodiment of the invention, the apparatus sends the specific order for the delivery to at least one second node in the cluster system. Sending the specific order to the at least one second node in the cluster system enables a sequence delivery not only to receivers on the first node but also to receivers registered for the event on the at least one second node.

In another embodiment of the invention, the apparatus comprises means for receiving a specific order for the delivery sent by at least a second node in the cluster system. Therefore, the apparatus controls and maintains the delivery of event messages to receivers registered for that event on a cluster-wide basis. It is preferred that the apparatus is provided in each node of the cluster system.

Delivering the event message comprises the steps of delivering the specific order to the at least one second node in the cluster system and also receiving a specific order of the at least second node of the cluster system; and finally delivering the event message to the at least two receivers dependent on the received specific order of the at least one second node.

Implementing the method in each node of the cluster system enables the delivery of event notifications on a cluster-wide basis in a specific order. This is specifically important if receivers on a first node are dependent on actions performed by receivers of a second node after the delivery of the event notification.

In another embodiment of the invention, the specific order sent or received comprises a node identification and the sequence number of the receiver to which the event message is to be delivered next. Receiving such a specific order from an apparatus of a second node allows the apparatus on the first node to decide when the delivery of the event notification to its receivers has to be done.

In one embodiment of the invention, the method comprises the step of registering a receiver for an event so that the event message will be delivered to said receiver.

In another embodiment of the invention, the method comprises the step of waiting for an acknowledgement of a first of the at least two receivers before delivering the event message to a second of the at least two receivers. Alternatively, an acknowledgement of a second node is waited for before delivering the event message to the receiver on the first node.

In another embodiment of the invention, the apparatus comprises means to indicate that the event notification has been delivered to all receivers.

In one embodiment of the invention, the apparatus is implemented by a software program executed and running on said at least one node.

In another embodiment of the invention, at least one of the two receivers is implemented by a software program.

### BRIEF DESCRIPTION OF THE DRAWINGS

FIG. 1 shows a cluster system for implementing the invention;

FIG. 2 shows a list of events and sequence numbers connected to receivers;

FIG. 3 shows a flow chart of operations for the inventive method;

FIG. 4 shows an exemplary sequence for implementing the inventive method;

FIG. 5 shows another example of a cluster system for implementing the invention; and

FIG. 6 shows a prior art cluster system.

### DETAILED DESCRIPTION OF THE DRAWINGS

The CF, GFS, GDS, ENS, SENS and OPS cluster software used for implementing the present invention, as described in detail below, is disclosed in the above-mentioned PRIMECLUSTER publication and in the publications listed in Chapter 1.2 thereof. The subject matter of such publications is hereby incorporated by reference.

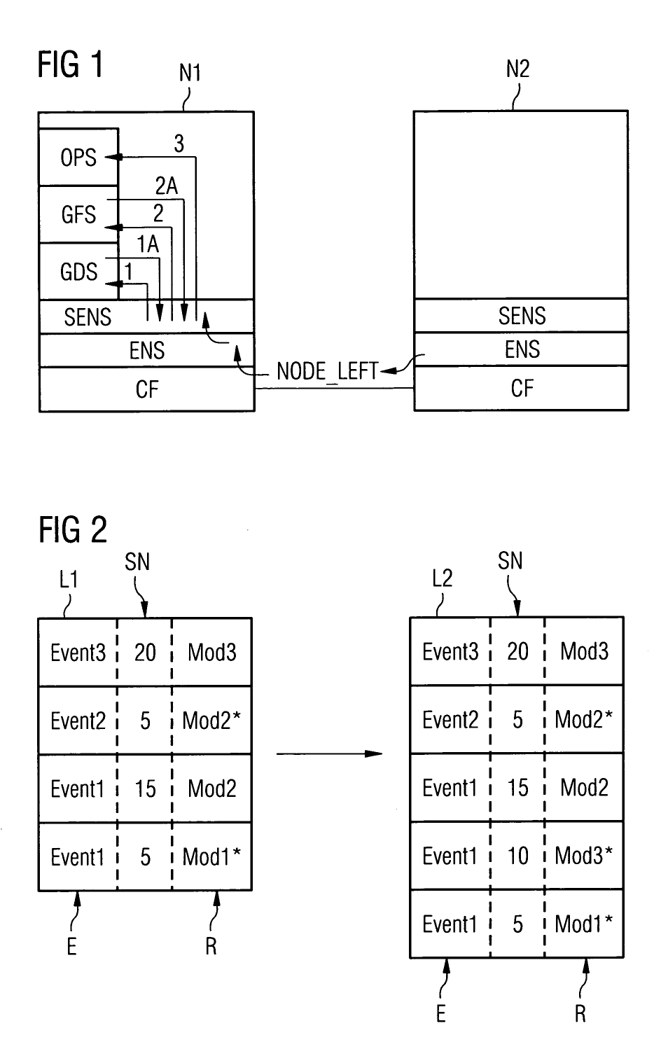

In FIG. 1, a cluster system with the implemented apparatus is shown. This apparatus includes SENS, CF, and ENS which include the functionality of receiving an event. The cluster system comprises two nodes N1 and N2 which are connected over a network N. On each node, the cluster foundation software CF is executed and running. The cluster foundation software CF provides the necessary functions for handling communication between the two nodes and especially for communication between additional cluster software running on the nodes. The cluster foundation software CF is the base layer for all cluster software. All other applications using functions of the cluster foundation have to register with the cluster foundation software CF. The registration can be done manually or, more commonly, via a script when starting the application. The cluster foundation software CF is also able to generate specific events messages and sends them over the network to the other nodes in the cluster system.

A specific module connected to the cluster foundation software CF is the event notification service ENS. The event notification service ENS provides a reliable event notification broadcast throughout the total cluster system. An event created by a cluster foundation software CF or by another software application running on a node is sent by the cluster foundation software CF to other nodes in the cluster. Depending on the event, the cluster foundation software CF sends the event to all other nodes or to specific nodes, respectively. The event or the event message is received by the cluster foundation software CF executed on a node and forwarded to the event notification system ENS on that node.

In the example shown in FIG. 1, the event notification service ENS of node N2 sends the event message NODE_LEFT to node N1. Such message is sent as soon as the node N2 starts to shut down or to leave the cluster. It will tell all cluster software on other nodes within the cluster system not to start new communications and to end existing communications as soon as possible. The cluster foundation software CF on node N2 receives that signal and forwards it to event notification service ENS of node N1.

The signal received by the event notification service ENS of node N1 is forwarded to the sequenced event notification service SENS coupled to ENS and to CF of node N1. The sequenced event notification service SENS is implemented by a software module and is responsible for a sequenced delivery of this event message NODE_LEFT to all executed cluster software needing that signal. In the example, the signal is needed by the cluster software GDS, GFS and OPS. Therefore, the sequenced event notification service has a registry, in which the receivers designated for a specific event can be registered. The receivers are, for example, the GFS and GDS cluster software. It is possible to register manually, but also automatically. In general the registry entry is a list, wherein all receivers for an event are stored. When a program registers itself to the CF, the SENS, ENS, CF or the program also decide whether it will be necessary to register also to the SENS. Those registries are often used in different OS (Windows registry for example).

Upon receiving the event message NODE_LEFT from node N2, the cluster software GDS stops writing data on a storage device on node N2. Furthermore, GDS starts reading and writing the data to a mirror storage device (not shown). As soon as the cluster software GDS has performed the task triggered by the receiving of the event message NODE_LEFT it will send the acknowledgement 1A to the sequenced event notification service SENS. The acknowledgement tells the software module SENS to deliver the event message NODE_LEFT to the next cluster software registered for that event.

The SENS will deliver the event to the global file system GFS. The global file system software GFS will also return an acknowledgement message 2A to the SENS after the task is done. Finally the event notification will be sent to the parallel data bank server OPS.

To manage the handling of the different event messages and also to control the sequence order of the delivery it is necessary that each receiver is registered with the sequenced event notification service SENS. The event notification service SENS will provide a list with all events and all registered receivers to those events. An example is shown in FIG. 2.

The list L1 contains three different events E, named Event1, Event2 and Event3. For the event Event1 two receivers R, named Mod1 and Mod2 are registered. For the event Event2 and the event Event3 only one receiver Mod2 or Mod3 respectively are registered. Furthermore, the list L1 contains a sequence number SN representing the order or the priority in which the events have to be delivered. The higher the priority for the event message to be delivered to the receiver, the lower the sequence number.

The receiver Mod1 has a sequence number of 5 for the event Event1. Thus, the receiver Mod2 has a sequence number 15 for the same event. Thus, the receiver Mod1 has a higher priority than the receiver Mod2 in delivering the event Event1. Therefore, upon receiving the event Event1, the sequenced event notification service SENS will forward the event Event1 to the receiver Mod1 first. The asterisk shown for the receiver Mod1 tells the notification service SENS to wait for an acknowledgement signal of the receiver Mod1 before delivering the event message Event1 to the next receiver in the list. The sequenced event notification system SENS will wait for an acknowledgement by Mod1 before delivering the event message Event1 to the receiver Mod2.

Upon receiving the event Event2 the SENS will deliver the event message of Event2 only to the receiver Mod2. Due to the asterisk it will also wait for an acknowledgement.

In list L2 an additional receiver Mod3 has been registered for the event Event1. As can be seen, the priority given for Mod3 by the sequence number is lower than the priority for the receiver Mod1 but higher than the priority for the receiver Mod2. After an event Event1 is received, the SENS will deliver the event message of Event1 first to the receiver Mod1, wait for an acknowledgement of that receiver Mod1, then deliver the event message of Event1 to the receiver Mod3. After an acknowledgement of receiver Mod3 it will finally deliver the event message to Mod2.

In this example, the sequence number is a numerical value. It is possible that two receivers share the same sequence number which results in a delivery of the event message by the SENS to both receivers at the same time. Furthermore, there is a maximum sequence number restricting the registration of different receivers with different priorities. In this example, event messages are delivered to the receivers (also referred to herein as handlers) respectively registered with a lower delivery sequence number before being delivered to a handler registered with a higher sequence number. Of course, a sequence number wherein a higher numerical value means a higher priority is also possible. Upon registration, the sequence number can be freely set by a user in the range from 1 through the maximum sequence number.

After the delivery of the event message of one specific event to all registered receivers the sequenced event notification service SENS will send a signal indicating that the delivery is completed. The indication signal is preferably given by a numerical value higher than the maximum sequence number. It can also be a negative numerical value.

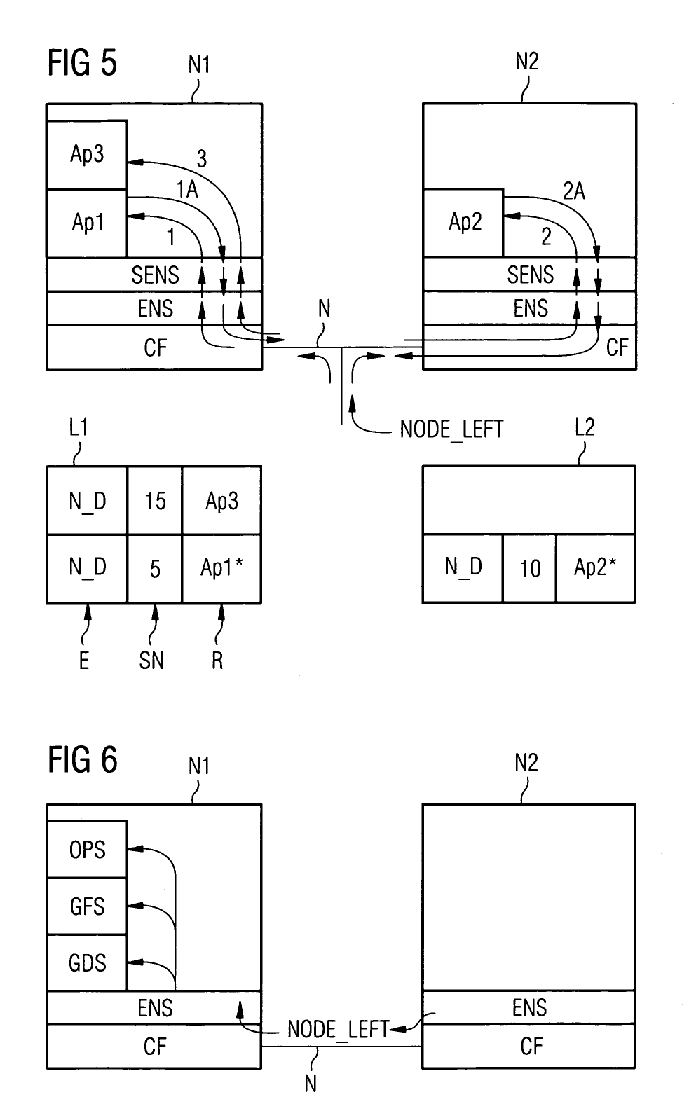

A second embodiment of the invention is shown in FIG. 5. This deals with the aspect that sometimes cluster software modules, or applications, are executed on different nodes. However, the software modules or applications are still dependent on each other. Therefore, it is not only necessary to provide a sequenced event notification on one specific node but also a sequenced event notification on a cluster-wide basis.

The cluster in FIG. 5 comprises two nodes N1 and N2 which communicate with each other over the network N. On both nodes the cluster foundation software CF is executed and the event notification service ENS as well as the sequenced event notification service SENS are connected to the cluster foundation software CF. Furthermore, the applications AP1 and AP3 are executed and running on node N1. Both applications are dependent on each other. The applications AP1 and AP3 are registered with a sequenced event notification service SENS for the event NODE_LEFT or N_D, as can be seen in list L1 of FIG. 5. According to the list maintained and controlled by the SENS, the application AP1 has the sequence number 5, while the application AP3 has a lower priority with its sequence number 15. On node N2, the application AP2 is executed and also registered to the event N_D with a specific priority given by the sequence number 10.

In this embodiment of the invention, both nodes receive the signal NODE_LEFT from within the cluster. The cluster foundation software forwards this event to the ENS and to the SENS. As can be seen from the lists L1 and L2, the event NODE_LEFT should be delivered according to the sequence number 5 first to the application AP1 on the node N1, then to the application AP2 on node N2, and afterwards to application AP3 on node N1 again.

To prevent errors due to false delivery, it is necessary that the sequenced event notification service SENS on both nodes are able to communicate with each other in order to maintain the correct delivery of the event message.

Data structures called node maps are used by the sequenced event notification service SENS on each node for this purpose. The node maps are updated and evaluated in order to control the sequencing on event deliveries throughout the cluster. The node map contains all nodes registered in the cluster and also information about each node. In this example, the information includes the status of the node and also the status of a sequenced event notification service SENS on that node. The status will tell whether the SENS is running on that node. Furthermore, each node map entry has the delivery sequence number of that specific node. The sequence number for the node in the map entry will always be the last delivery sequence number that the respective node has requested for making a delivery.

For example, when a SENS on a node wants to deliver the event to a receiver it has registered to receive the event at sequence number 2, it informs all other nodes in the cluster about that sequence number. This is done by sending a node map with the node's name and the sequence number 2 to the other nodes. This will cause the sequenced event notification service SENS on the other nodes to update their node map with a new sequence number of 2 for the requesting node.

Furthermore, the requesting node waits to be informed that all other nodes have requested a sequence number of 2 or higher before making the delivery. If a sequential event notification service SENS on another node has an entry with a lower sequence number, i.e. a higher priority, it will deliver first. The sequential event notifications services SENS on all the nodes share the same information by sharing and updating the node maps. An event is delivered to the receiver with the lowest number, i.e. with the highest priority.

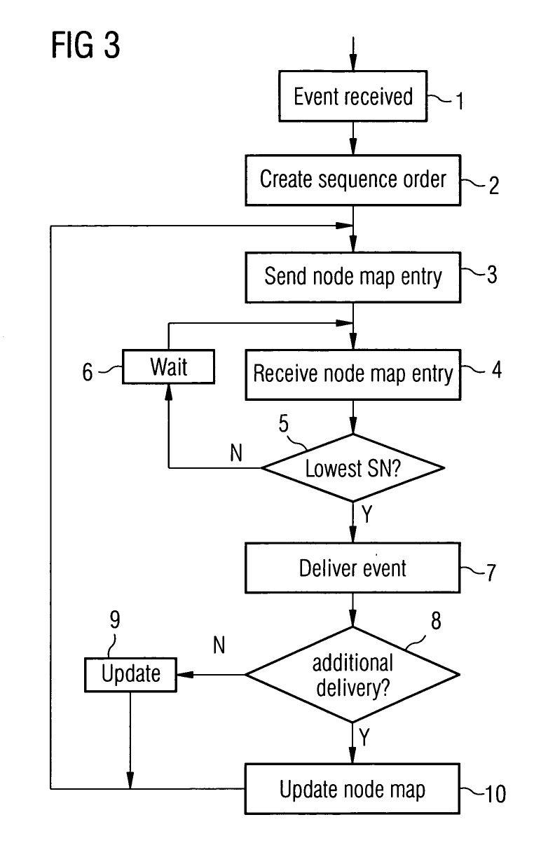

This method is explained in more detail in conjunction with FIG. 3. The method is implemented in the sequenced event notification service SENS for one node. After receiving an event message in step 1, the sequenced event notification service SENS creates the sequence order for that event. It collects all receivers registered for that event and in step 2 puts them in the order according to their sequence number to be connected to the receivers, just as shown in FIG. 2. In the next step, the SENS picks the lowest sequence number for the event message to be delivered to a receiver and per step 3 sends this sequence number together with its node identification as a node map entry to all the other nodes in the cluster.

The node then waits to receive the node map entries of the other nodes. The map messages of the other nodes received by the sequenced event notification service SENS in step 4 include the node identification and the sequence number for the next delivery on each node. The sequenced event notification service SENS will update its own node map with the information received in the map messages. It will then evaluate whether its own sequence number is the lowest number among the node map entries.

If that is not the case, the node will wait per step 6 for a specific amount of time in order to receive new node messages and update its own node map again. If its sequence number to be delivered is the lowest number, the sequenced event notification service SENS will deliver the event to the registered receiver, per step 7.

Afterwards, the SENS checks per step 8 whether additional receivers are registered for an event notification delivery with a higher sequence number. If that is the case, it will update its own node map per step 10 with a new sequence number, then jump back to step 3 and repeat sending the message including node identification and sequence number to the other nodes in the cluster. If there are no more deliveries to do, the sequenced event notification service SENS will update its own map per step 9 with a done indication signal and will also send this indication signal in step 3 to all other nodes in the cluster.

In the example of FIG. 5, the sequenced event notification service SENS of node 1 will send a map message containing the name of node 1 named N1 and the sequence number 5 to the SENS of node N2, while the SENS of node N2 will send a map message including the sequence number 10 to node N1. The SENS of node N1 can start delivering the event message to AP1 because sequence number 5 is the lowest number in the cluster system. After receiving an acknowledgement of application AP1, N1 creates a new map message containing the sequence number 15 and its own node name N1, and sends this map message to the SENS of node N2.

After updating and evaluating the node map, the sequenced event notification service SENS of node N2 starts the delivery of the event notification N_D to application AP2 and waits for an acknowledgement. After receiving the acknowledgement of the application AP2, node N2 creates the signal “done” and sends the signal back to the sequenced event notification service SENS of N1. The SENS of node N1 can then start making the remaining deliveries.

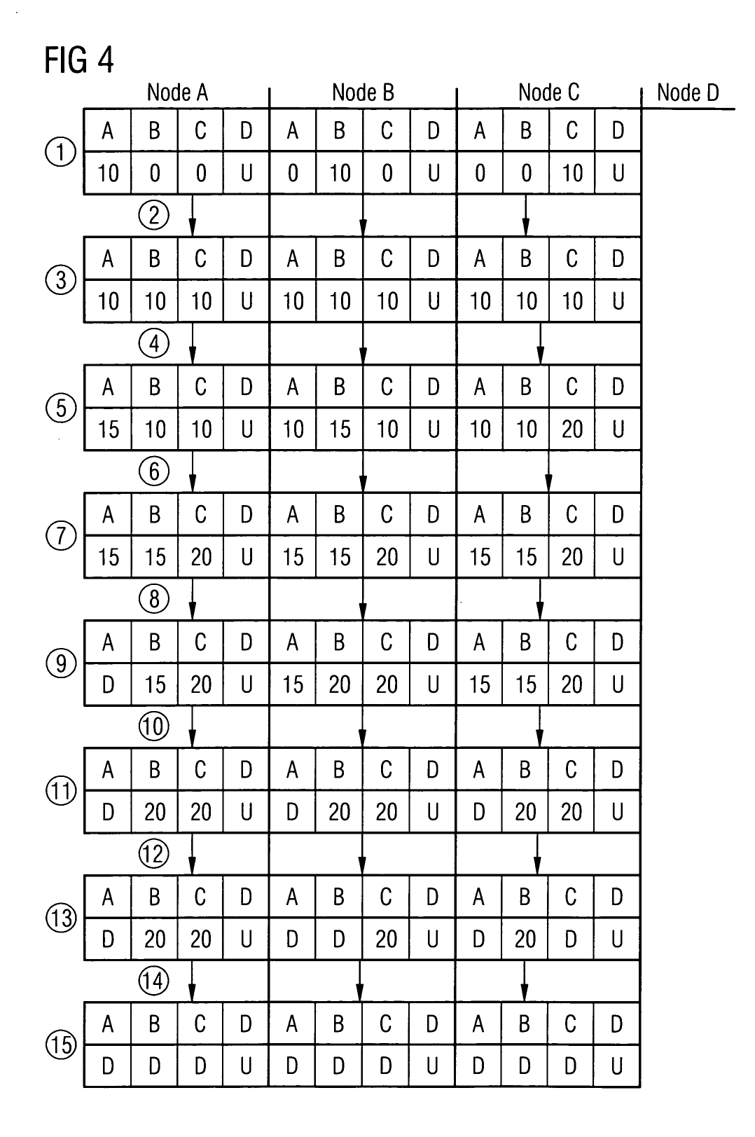

A more complex example for the method implemented in the system event notification services can be seen in FIG. 4. In this example, the cluster comprises four nodes: Node A, Node B, Node C and Node D. A sequenced event notification service is executed on Node A, Node B and Node C. The SENS on each node provides a node map comprising the information shown in FIG. 4.

The node map of Node A comprises node names A, B, C, D and the information provided by them. In the first step, no message by any other node is received yet, and the sequence number of Nodes B and C is set to an initial 0. This is called an initial node map and is used as a start node map for each new event. As can be seen from FIG. 4, the status of node D is marked U, for unknown, because no sequenced event notification service SENS is running on Node D. It will be neglected by the event notification service SENS on the other nodes.

In step 2, each of the nodes Node A, Node B and Node C sends a map message to the other nodes containing its lowest sequence number as well as its node name. After updating the node maps on all the nodes with the received priorities, the node maps contain the information shown in step 3. Since the lowest sequence number for all nodes is 10, the sequenced event notification service SENS of all the nodes immediately start making the delivery to the registered receivers. After that, the nodes update their own node maps in step 4.

In step 5, the node maps for each node can be seen. The next sequence number for making a delivery on Node A and Node B is 15, while the next sequence number on Node C is 20. In step 6, the sequenced event notification service SENS on the nodes will send messages with the next sequence number for each other node. After merging and updating the node maps, the maps on each node contain the sequence number 15 for Nodes A and B, and the sequence number 20 for Node C. Therefore, the nodes A and B start making their delivery to the registered receivers, while the sequenced event notification service SENS on Node C must wait until the node map is updated.

In step 8, the sequenced event notification service SENS updates its node map again. For node A no more receivers are registered for that event. Therefore, it updates its own node map with a signal D for “Done”. Node B has to do a delivery at the sequence number of 20, while the node map of Node C is not updated because the delivery has yet to be made. After exchanging the map messages and updating the maps, the step 11 shows the node maps on each node. The SENS on Node B and Node C can start making the delivery immediately due to their having the same sequence number. They do not wait for the sequenced event notification service SENS on Node A because Node A has already finished making its deliveries. After updating its own node maps, and sending and receiving the map messages from the remaining nodes, the node maps on each node are shown in step 15. As soon as all nodes have sent a “Done”-signal D, the delivery for the event is complete.

In this embodiment of the invention, the “Done”-signal is implemented by a numerical value greater than the maximum sequence number. Furthermore, the SENS software application provides a service function that will be used to detect the presence of a sequenced event notification service SENS on a node. This will allow sequenced notification services SENS on the other nodes to update their own node maps with a new node or a new SENS in order to provide a correct delivery of received events.

The foregoing description of various embodiments of the present invention has been presented for purposes of illustration and description. It is not intended to limit the invention to the precise form disclosed, and many modifications and variations are possible in the light of the invention. Especially the different aspects and embodiments of the invention can be combined in any way without limiting the scope. For example, it is possible to provide a local event handler responsible for delivering local events to the applications. It might also be necessary to implement special procedures for specific events, for example if the sequence order for an event changes during the delivery of such an event.

It might also be necessary to provide a unique identification for each event. This is necessary because the duration for an event until a complete delivery can be very long due to the sequenced event notification. For example, a node broadcasts some events that require sequence delivery, leaves the cluster, rejoins the cluster again and starts to broadcast the same events again before the delivery is finished. This can lead to confusion. Therefore, a node generation number is required for a unique event identification.

The node generation number is a unique identification for a specific event on a specific node. Upon the identification, a SENS of a node within the cluster can decide whether a specific event of the node has already been received and forwarded, whether it has still to be forwarded, and so on. This means that an event shall have an identification comprising a node where identification of that node the event was generated, e.g., node A generates an event, then the event might have the identification 001A, wherein 001 is a simple counter and “A” is the unique node IID. The node generation number is quite common. For example, the IP address of a node or the MAC address can be used for that purpose.

Another useful implementation is implemented by an extension of the sequenced event notification service SENS to provide a method for receiving sequenced event notifications by a user process. A user process is a process normally started manually and not registered to the CF. The extension enables sending event messages to user processes and to receive events by user processes. Examples of a user process sending events to the CF are the “shutdown” and “unmount” commands in the Unix enviroment. If the SENS is implemented in the kernel, such extension can be readily performed, because Unix kernels can provide a very powerful and flexible event handling management. Implementing the SENS using a kernel module, driver or demon within the operating system allows an easy extension with functions for a user sequenced event notification. The receivers, of course, should be able to handle the event messages they are registered for.

The scope of protection of the invention is not limited to the examples given hereinabove. The invention is embodied in each novel characteristic and each combination of characteristics, which includes every combination of any features which are stated in the claims, even if this combination of features is not explicitly stated in the claims.

1. An apparatus for use in at least one node of a cluster system, wherein the cluster system comprises at least two nodes in communication with each other over a network, and at least one node comprises at least two receivers coupled to said apparatus via a connection, wherein said apparatus comprises:
means for receiving an event message related to an event occurring within the cluster system; and
means for delivering the event message to the at least two receivers via the connection in a specific order determined by a sequence number assigned to each one of the at least two receivers.

2. Apparatus of claim 1, wherein the apparatus comprises means for sending the specific order for the delivery to at least one second node in the cluster system.

3. Apparatus of claim 1, wherein the apparatus comprises means for receiving the specific order for the delivery sent by at least a second node in the cluster system.

4. Apparatus of claim 1, wherein said specific order sent or received comprises a node identification and the sequence number of the receiver the event message is to be delivered to next.

5. Apparatus of claim 1, wherein said apparatus comprises means for registering a receiver for the event.

6. Apparatus of claim 1, wherein the apparatus comprises means for receiving an acknowledgement from at least on of the at least two receivers.

7. Apparatus of claim 1, wherein the apparatus comprises means for indicating a complete delivery to all receivers.

8. Apparatus of claim 1, wherein the apparatus is implemented by a software program executed and running on said at least one node.

9. Apparatus of claim 1, wherein at least one of the at least two receivers is implemented by a software program executed and running on said at least one node.

10. A method for controlling delivery of an event message related to an event occurring in a cluster system, wherein the cluster system comprises at least two nodes, and at least one of the at least two nodes comprises at least two receivers, wherein the method is implemented in the at least one of the at least two node and comprises the steps of:
a) receiving the event message to be delivered to the at least two receivers; and
b) delivering the event message to the at least two receivers in a specific order determined by a sequence number connected to each of the at least two receivers.

11. Method of claim 10, wherein the method comprises the step of
registering of an additional receiver for an event message of an event to be delivered to said additional receiver.

12. Method of claim 10, wherein step b) comprises the step of:
waiting for an acknowledgment of the first of the at least two receivers before delivering the event message to the second of the at least two receivers.

13. Method of claim 10, wherein step b) comprises the step of:
delivering the specific order to the cluster system;
receiving a specific order of the at least second node of the cluster system; and
delivering the event message to the at least two receivers depending on the received specific order of the at least second node.

14. Method of claim 13, wherein the specific order sent or received comprises a node identification and the sequence number of the receiver the event message is to be delivered to next.

15. Method of claim 10, wherein the event message is delivered to a software module comprising a receiver, said software module executed and running on said at least one node.

16. Method of claim 10, wherein the method comprises the step of:
delivering an indicating signal to the at least one second node after the event message has been delivered to each of the at least two nodes.
